(19) United States
(12) Patent Application Publication
(10) Pub. No.: US 2010/0208017 A1
(43) Pub. Date: Aug. 19, 2010

(54) IMAGING MODULE FOR HOT MELT WAX INK JET PRINTER

(75) Inventors: Richard N. Florence, Tolland, CT (US); Raymond J. MacQueen, JR., Barkhamsted, CT (US); Elaine A. Pullen, West Hartford, CT (US); Graham D. Walter, New Ipswich, NH (US); Robert L. Wiita, Harrisville, NH (US); William Parker Alexander Wright, Charlottesville, VA (US)

Correspondence Address: CANTOR COLBURN, LLP, 20 Church Street, 22nd Floor, Hartford, CT, 06103, US

(73) Assignee: BLACK DOT TECHNOLOGY, INC., Avon, CT (US)

(21) Appl. No.: 12/708,592

(22) Filed: Feb. 19, 2010

Related U.S. Application Data
(60) Provisional application No. 61/153,691, filed on Feb. 19, 2009.

(51) Int. Cl. B41J 2/175

(52) U.S. Cl. 347/88

(57) ABSTRACT

An imaging module includes an ink jet print head for printing human-readable or coded (e.g., bar code) information directly onto various porous and non-porous materials (e.g., a corrugated cardboard container), and a pair of reservoirs that hold the melted ink ultimately used in the printing process. The module also includes an ink feed hopper into which one or more solid sticks of hot melt wax ink are fed and an associated heater to melt the ink sticks in limited volume, together with associated vents, control pumps and valves, all integrated together within the imaging module to deliver the melted ink to the print head for printing on a container or other items.

### CROSS-REFERENCE TO RELATED APPLICATIONS

This application claims the benefit of U.S. Provisional Application Ser. No. 61/153,691, entitled “Imaging Module For Hot Melt Wax Ink Jet Printer,” filed Feb. 19, 2009, which is incorporated herein by reference in its entirety.

### FIELD OF THE INVENTION

The present invention relates in general to ink jet printers, and in particular, to an imaging module for a hot melt wax ink jet printer primarily used for industrial packaging printing or coding applications, e.g., for cardboard containers, wherein the imaging module may comprise a self contained module having a print head, an ink hopper that melts the ink, one or more ink storage reservoirs, a power supply for providing power for heating the printer and ink, and an external magazine for a bulk ink supply, all integrated together as a module.

### BACKGROUND OF THE INVENTION

Ink jet printers have been used for some time for home, office and industrial printing applications. Ink jet printers for the home and office typically use water-based inks that require cleaning of the print head to prevent ink from drying up and possibly causing a failure. These cleaning systems are integrated into the printer and are not typically used in industrial ink jet printers for coding applications. Some industrial ink jet printers use an oil-based ink, which is necessary to ensure that the ink does not dry up in the print head or block a jet and possibly cause a failure. However, these printers, which are based on relatively high-resolution piezoelectric technology, are messy to operate and difficult to clean up, primarily due to the oil-based inks involved. Also, these printers may only be used on porous materials (e.g., corrugated cardboard) because they require absorption of the oil-based ink into the material for the ink to dry properly. Oftentimes the oil-based ink continues to bleed for a while after printing. As a result, printed information, for example, bar codes, which may initially be machine-readable right after printing often stops being machine-readable merely hours after printing. The oil-based inks are also harmful to the bearings of conveyor belt rollers, upon which conveyor belt the packages proceed along an assembly or production line. This causes the need and associated cost to replace the bearings relatively frequently, also causing wasted downtime on the assembly or production line. Also, oil-based inks have a relatively short shelf life and require proper disposal.

Further, the printing of plastics and other non-porous materials used primarily in the food industry normally requires solvent ink in order for the ink to dry in a relatively rapid time frame. Many food products need to be stored in moisture resistant packaging, which is typically a UV clear-coated plastic material upon which oil-based inks will not dry and for which UV curable inks are typically not used due to the associated increased cost and safety concerns. An example of a solvent-based ink jet printer is one based on continuous jet technology. Such solvent inks have become increasingly problematic due to safety, shipping and environmental concerns, as these inks typically release volatile organic compounds into the environment. Also, the solvent inks require proper storage for such flammable liquids as well as proper waste disposal.

Nevertheless, despite these drawbacks, oil-based ink jet printing systems have continued to be used in various industrial markets in a wide variety of different applications. More recently, relatively high-resolution ink jet printers have been available that can print characters or codes approximately two inches in height in a single pass. Contrast this to bubble jet printers that can typically only print at a height of less than one-half inch and require multiple passes across the printing surface, or to be stacked in an array which can lead to gaps and alignment defects, to adequately print the desired characters or codes. As a result, the relatively high-resolution ink jet printers create significant demand for replacing printed paper labels used on shipping containers with the printing of bar codes and other text or codes directly onto the shipping containers as they move along a production or assembly line. Ink jet printers continue to provide compelling economic advantages (e.g., significantly lower cost to print a bar code directly onto a container versus using a pre-printed label) and, additionally, as the associated coder typically comprises a computer-based digital printer, the coder can change the code to be printed from box to box, thereby allowing significantly fewer containers to be held in inventory.

In contrast, hot melt wax ink suffers from few, if any, of the aforementioned problems associated with oil-based inks and solvent inks. Hot melt wax ink comprises a thermo-plastic, non-hazardous material, which is solid at room temperature, and is therefore relatively clean and safe to handle. Hot melt wax ink requires heating by the ink jet printer in order to expel the ink drops, but the hot liquid ink dries instantly on the printed surface. Therefore, there are no messy spills to clean up or that could cause problems with other pieces of equipment. Any “spilled” hot melt wax ink is simply picked up after it hardens and discarded with normal waste. Hot melt wax ink prints onto a relatively wide range of porous and non-porous materials with relatively no mess (as compared to that associated with oil-based inks). Also, hot melt wax ink requires no solvents, nor any special shipping and waste disposal or cleanup, which appeals to increasing environmental concerns and regulations. Further, hot melt wax ink has a relatively long shelf life, which is another cost savings benefit.

There exists in the art a relatively high resolution, hot melt wax ink printing or coding system capable of printing bar codes on various materials such as cardboard and plastics. However, problems with this system include the fact that it takes a relatively long time for the system to heat up to operating temperatures (primarily because all of the ink needs to be melted in the reservoir), and the system consumes a relatively large amount of electrical power. This becomes an issue when the system needs to be halted for any reason and then restarted, or the system is moved to a different production or assembly line.

Other known hot melt wax ink printers or coders are “distributed” systems in that the printer or coder basically comprises a system of separate components, instead of a self contained system. For example, the components for storing, melting and pumping the heated ink may each be housed in its' own housing, with the housings being separate from one another. Further, a heated cord or tube is used to deliver the melted ink to the print head, which may be a stand-alone device positioned on the conveyor that carries the, e.g., boxes or other items to be printed. Problems with these types of distributed systems include the fact that they are relatively energy intensive as they typically heat the ink in a control unit, and then additional energy is utilized to pump the ink through the heated tube. Also, such distributed systems inherently contain a relatively high number of parts, each part having to be heated to maintain the ink in a liquid state and a relatively large number of heated couplings is required to connect each part, which, when added up, reduces the reliability of the overall distributed system. The distributed system is typically large in size, thereby requiring careful installation, for example, the careful locating or running of the tubes containing the heated ink so that they are not subject to accidental damage during production operations. Also, since production operations typically must accommodate a variety of carton or package sizes, a distributed system requires that the various tubes be moved to meet the demands of printing on the various carton or package sizes. Further since the tubes carrying the ink must be heated to a relatively high temperature, such heated tubes represent a potential safety hazard if they were to be damaged.

What is needed is an imaging module for a hot melt wax ink jet printer that is used primarily for industrial packaging printing or coding applications in which the imaging module contains both the print head and one or more ink reservoirs integrated together with other components in a single module, thereby allowing for a relatively short time to heat up to operating temperatures, lower usage of electrical power, and also allowing for relatively clean, solvent-free printing or coding for a wide range of packaging materials, for example, cardboard shipping boxes, plastic films and printed cardboard for use in industries, such as, e.g., food and beverage, pharmaceuticals, cosmetics, automotive, etc. In addition, such an imaging module ideally overcomes the shortcomings of the distributed systems discussed hereinabove, in that the module has increased safety, increased production changeover flexibility (i.e., the imaging module can be moved without moving any heated tubes), increased installation flexibility, increased reliability, and reduced energy consumption.

### SUMMARY OF THE INVENTION

According to an embodiment of the invention, a self contained imaging module includes a print head for printing human-readable or coded (e.g., bar code) information directly onto various porous and non-porous materials (e.g., a corrugated cardboard container), and a pair of reservoirs that hold the melted ink ultimately used in the printing process. The module also includes an ink feed hopper into which one or more solid sticks of hot melt wax ink are fed and an associated heater to melt the ink sticks in limited volume, together with associated vents, control pumps and valves, all integrated together within the imaging module to deliver the melted ink to the print head for printing human-readable text or codes on a container or other items.

According to another embodiment of the imaging module of the present invention, a portion or all of the ink feed hopper may be located external to the imaging module (for example, on top of the imaging module), thereby allowing for a greater number of ink sticks or pucks to be loaded into the imaging module for subsequent melting and printing. In this embodiment, the ink hopper or magazine may be considered a bulk ink magazine.

According to yet another embodiment of the imaging module of the present invention, an extended housing may be included that includes various additional components of the imaging module, such as one or more power supplies, a vacuum pump, an AC power and line filter module, and a circuit board that contains various components that control certain functions of the imaging module.

According to yet another embodiment of the imaging module of the present invention, an adaptor in the form of, e.g., a plate, may be included that includes one or more heaters and one or more ink feed paths, such adaptor allowing the print head to be positioned in a variety of orientations relative to the ink reservoirs. In this embodiment, one such adaptor will allow the print head to print a vertical image onto a surface moving horizontally past the imaging module. In another embodiment, such adaptor will allow the print head to print downwards and in another embodiment, such adaptor will allow the print head to print an image across a surface moving vertically past the imaging module.

### BRIEF DESCRIPTION OF THE DRAWINGS

The various embodiments of the present invention can be understood with reference to the following drawings. The components are not necessarily to scale. Also, in the drawings, like reference numerals designate corresponding parts throughout the several views.

FIGS. 1 and 2 are perspective views of an embodiment of an imaging module according to the present invention;

FIG. 3 is a schematic diagram of various components that make up the imaging module of FIGS. 1 and 2;

FIG. 4 is a side view of an embodiment of the imaging module of the invention;

FIG. 5 is a top view of an embodiment of the imaging module of the invention;

FIG. 6 is a front view of an embodiment of the imaging module of the invention;

FIG. 7 is a rear view of an embodiment of the imaging module of the invention;

FIG. 8 is another front view of an embodiment of the imaging module of the invention;

FIG. 9 is a cross-sectional view of the embodiment of the imaging module of FIG. 8 taken along the lines A-A of FIG. 8;

FIG. 10 is a cross-sectional view of the embodiment of the imaging module of FIG. 8 taken along the lines B-B of FIG. 8;

FIG. 11 is a side view of an embodiment of the imaging module of the invention with the side removed;

FIG. 12 is a top view of an embodiment of the imaging module of the invention with the top removed;

FIG. 13 is another side view of an embodiment of the imaging module of the invention with the opposing side removed;

FIG. 14 is a perspective view of an alternative embodiment of the imaging module of the present invention having an external bulk ink magazine;

FIG. 15 is a perspective view of an alternative embodiment of the imaging module of the present invention having an extended housing that contains various components of the imaging module;

FIG. 16 is a side view of the alternative embodiment of the imaging module of the present invention of FIG. 15 having an extended housing that contains various components of the imaging module;

FIG. 17 is a side view of an alternative embodiment of the imaging module of the present invention having an adaptor plate to position the print head to print downwards;

FIG. 18 is a bottom isometric view of the alternative embodiment of the imaging module of the present invention of FIG. 17; and

FIG. 19 is a front isometric view of the alternative embodiment of the imaging module of the present invention of FIG. 17.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

In embodiments of the invention, an imaging module includes a print head for printing human-readable or coded (e.g., bar code) information directly onto various porous and non-porous materials (e.g., a corrugated cardboard container), and a pair of reservoirs that hold the melted ink ultimately used in the printing process. The module also includes an ink feed hopper into which one or more solid sticks of hot melt wax ink are fed and an associated heater to melt the ink sticks in limited volume, together with associated vents, control pumps and valves, all integrated together within the imaging module to deliver the melted ink to the print head for printing on a container or other items.

The foregoing and other features of various disclosed embodiments of the invention will be more readily apparent from the following detailed description and drawings of the illustrative embodiments of the invention wherein like reference numbers refer to similar elements.

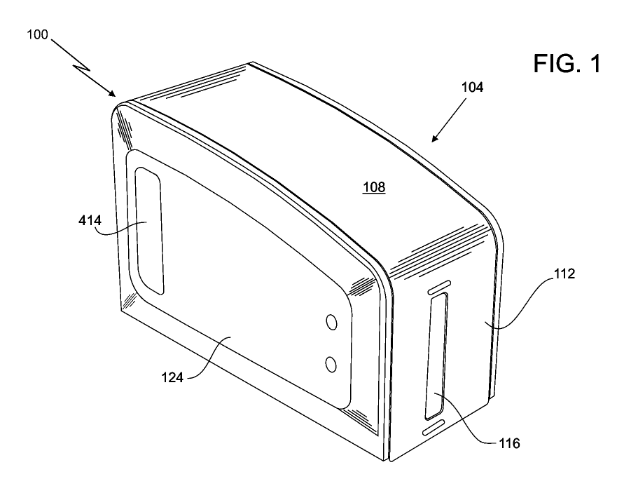

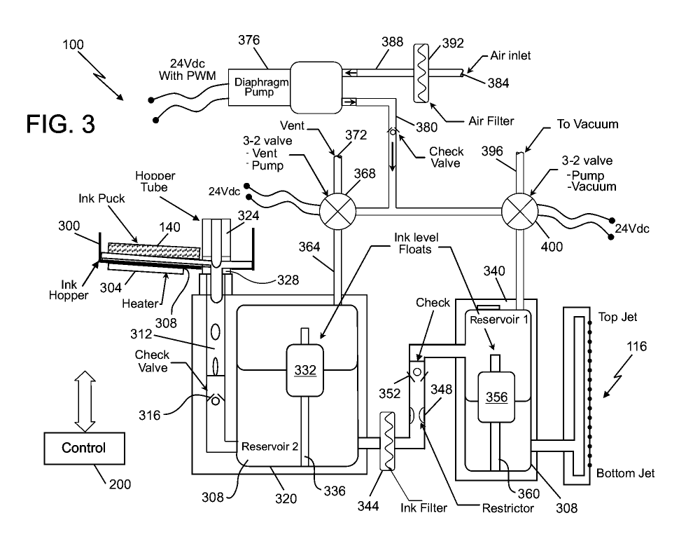

Referring to FIGS. 1 and 2, there illustrated are perspective views of an embodiment of an imaging module (“IM”) 100 according to the present invention. The imaging module 100 comprises an outer casing 104 that includes a top 108, a front 112 with an opening for an array of output jets of a hot melt wax ink jet print head 116, which is described in detail hereinafter, a rear 120, two opposing sides 124, 128, and a bottom 132. The top 108, the front 112, and the rear 120 may comprise stainless steel or other suitable material. The sides 124, 128 may comprise a plastic material (e.g., ABS, nylon) or other suitable material. The bottom 132 may comprise aluminum or other suitable material. Not shown in FIGS. 1 and 2 is an optical sensor which may be attached to either one of the sides 124, 128 (FIG. 4). The optical sensor is utilized to detect when a leading edge of a container or other item to be printed by the imaging module 100 passes on a conveyor belt sufficiently close to the print head 116 to then trigger the printing of characters and/or codes on the container.

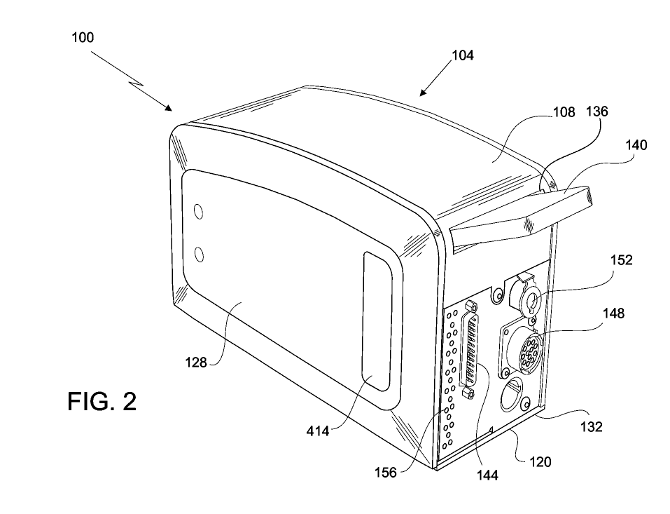

FIG. 2 shows that the rear 120 includes a slot or opening 136 through which an ink stick or “puck” 140 may be passed through and into an ink hopper (FIG. 3) within the imaging module 100 for subsequent storage and melting “on-demand” (i.e., when the melted ink is required for printing onto a container or other item), as described in detail hereinafter. Such “on-demand” usage of the ink puck 140 reduces power consumption of the imaging module 100 and any potential for spills of the hot melt wax ink material. The ink puck 140 may comprise a solid wax material generally in the shape of a rectangle, although other shapes for the ink puck 140 may be utilized. One or more ink pucks 140 may be loaded into the ink hopper through the opening 136 (e.g., in an embodiment, the ink hopper may hold up to three ink pucks 140). The shape and size of the ink puck 140 depends upon the corresponding shape and size of the ink hopper utilized within the imaging module 100. The ink puck 140 may comprise a polymer material having a colored dye mixed in, wherein various dyes are utilized to achieve different colors of ink or pigments may be used to color the ink. An exemplary ink puck size may be approximately 68 cubic centimeters, although other suitable sizes may be utilized. The size of the ink puck 140 depends in part on the size of the ink hopper utilized within the imaging module 100.

The rear 120 also includes a data communication port connector 144 for connecting to a control device 200 (FIG. 3) for communication therewith (e.g., transmitting and receiving data including the codes to be printed). The control device 200 may comprise a programmed computer or similar device that receives signals from and controls various components and aspects of the operation of the imaging module 100. The rear 120 further includes a power connector 148 for connection to the control device 200 for receiving various types of electrical power therefrom for usage by the various powered devices within the imaging module 100. Also, the rear 120 includes a vacuum port 152 for receiving a vacuum source from the control device 200 or other equipment. Still further, the rear 120 includes a number of openings 156 (e.g., round holes) that allow for the intake and exhaust of air into and out of the imaging module 100 to improve the thermal performance of the imaging module 100, as described in detail hereinafter.

Various mounting brackets and box guides (not shown) may be used to mount the imaging module 100 of embodiments of the present invention to an assembly or production line on which various containers or other items of different shapes and sizes travel along. The box guides ensure that the containers pass sufficiently close to the print head 116 of the imaging module 100 for proper printing of various characters and/or codes (e.g., bar codes) thereon.

The different types of package printing or coding applications include primary packaging, which typically includes plastic films or coated papers. In these applications, text or codes such as a part number, serial number, and “best used by” date are typically desired to be printed. Another application includes intermediate packaging, which usually includes coated cardboard packaging for a plurality of, e.g., food products on which a part number, serial number, date and time of production, and “best used by” date are desired to be printed. A still further application includes secondary packaging, which may include a corrugated shipping container that typically already has pre-printed information thereon. There is a desire to print additional “variable” information on the container in the form of, e.g., a bar code, text (“product identification number”) and/or graphics.

Typically, a corrugated cardboard shipping container requires a bar code and/or text to be printed that varies from containers to container (e.g., variable coding). Also, corrugated shipping containers are normally made from two types of corrugated material: a first portion that is approximately 80% porous, having a relatively high recycled material content that may cause inconsistent print quality using traditional oil- and water-based inks; and a second portion that is approximately 20% non-porous, which in general cannot be printed using oil-based inks, nor can this portion be reliably printed with a solvent ink using piezoelectric ink jet technology. However, the use of a hot melt wax ink in conjunction with the imaging module 100 of various embodiments of the present invention allow for both the porous and non-porous portions of a typical corrugated cardboard shipping container to be printed with improved contrast (i.e., a darker image which improves bar code readability on, e.g., recycled cardboard) for relatively better print quality, and using a wax ink that is clean to handle and relatively safer than traditional oil-based or solvent inks for food and beverage packages. Also, relatively small character codes may also be printed with hot melt wax ink on primary packing materials.

While the description herein is primarily for printing human-readable and coded information directly onto packaging material, embodiments of the present invention may be used in a wide range of applications for a hot melt ink and may include the printing of any graphical image or the deposition of a material such as an image, coating, additive or structure. The use of the term hot melt ink or ink shall be understood to include any material which is substantially solid at room temperature and liquid when heated to the jetting temperature.

Referring to FIG. 3, there illustrated is a schematic diagram of an embodiment of an imaging module 100 of the invention depicting the various components that make up the imaging module 100. The imaging module 100 includes an ink hopper 300, into which the solid mass ink pucks 140 are loaded when inserted through the opening 136 in the rear 120 of the module 100. The ink hopper 300 may comprise aluminum or other suitable material that has good thermal conductivity. In an embodiment, up to three rectangular-shaped ink pucks 140 may be stacked vertically on top of each other in the ink hopper 300. However, more or less than three ink pucks 140 may be utilized, depending upon the amount of ink desired for printing over a period of time. Also, the ink placed in the hopper 300 may take on any other suitable shape (e.g., chips, pellets, block form, etc.). The ink hopper 300 may have a relatively wide flat bottom, to provide enough surface area so that the ink puck 140 can be melted quickly and efficiently. A film heater 304 may be attached to the bottom surface of the ink hopper 300 for relatively quick heating and, thus, melting of the ink puck 140 in the hopper 300. The heater 304 may comprise a commercially available Kapton® polyimide thermo foil flexible film heater which typically connects to a source of electrical power from, e.g., the control device 200. When melted ink is needed for printing, the heater 304 is activated (e.g., by applying power thereto), which melts a portion of the ink puck 140. The melted ink 308 passes down a drainpipe 312, through a check valve 316, and into an ink reservoir (“Reservoir 2”) 320, which acts as a “buffer” reservoir.

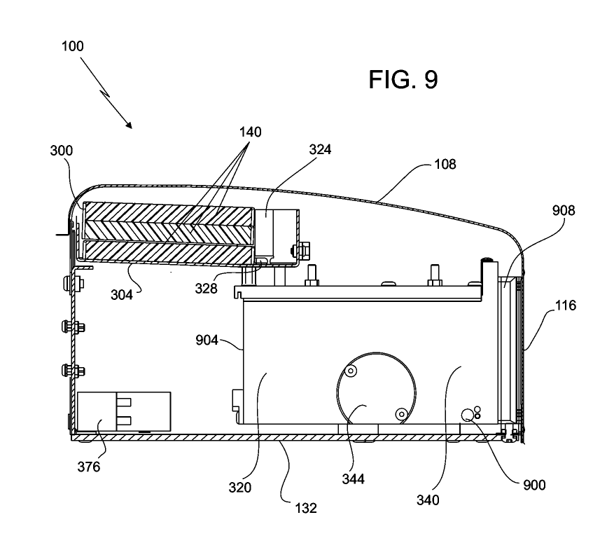

The ink hopper 300 may include a tube or pipe 324 that protrudes above the ink pucks 140 in the hopper 300. The tube includes an opening 328 (e.g., a slot) formed therein. The vented tube 324 allows air to escape as the ink is melting, which facilitates the flow of the melted ink 308 down the drain pipe 312 and into the buffer reservoir 320. The vented tube 324 helps to ensure that the heater 304 melts only enough of the solid ink 140 that is needed at any one time for maintaining ink levels in either reservoir 320, 340, after which the melted ink 308 re-solidifies within the hopper 300 when the heater is deactivated. The vented tube 324 performs the added function of properly positioning the ink pucks 140 in the hopper 300 near the heater 304 such that the melted ink 308 flows within the hopper 300, which is inclined at a downward angle, towards the hopper tube 324 (FIG. 9). This helps to prevent a dam of ink 308 from forming in front of the hopper tube 324, which could also create an undesirable surge of melted ink 308.

The buffer reservoir 320 may comprise aluminum or other suitable material with good thermal conductivity. The buffer reservoir 320, which may be considered to be the melted ink “staging” reservoir, includes an ink level float switch 332 that moves up and down with the level of melted ink 308 in the reservoir 320 on a stem 336 made from aluminum or other suitable material. The imaging module 100 also includes another reservoir 340 (“Reservoir 1”) that connects with the buffer reservoir 320. This reservoir 340 may act as the “print head” reservoir and may also comprise aluminum or other suitable material. Disposed between the buffer reservoir 320 and the print head reservoir 340 is an ink filter 344 (e.g., less than 10 microns opening size), a restrictor 348, and a check valve 352. The restrictor 348 is used to reduce the flow rate of the melted ink into the print head reservoir 340 such that the print head reservoir 340 does not see any pressure pulses.

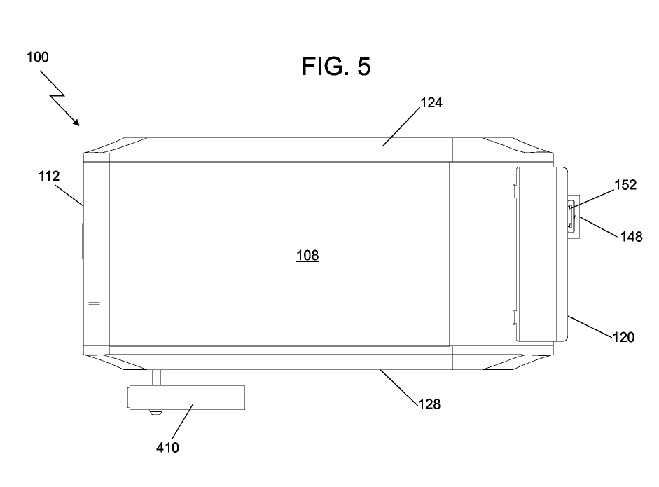

The print head reservoir 340 may also contain an ink float switch 356 that moves up and down with the level of the melted ink 308 in the reservoir 340 on a stem 360 made from aluminum or other suitable material. Although not shown in FIG. 3, each reservoir 320, 340 includes a heater (FIG. 9) for heating the melted ink 308 to keep it in its melted state within the corresponding reservoir 320, 340 for printing. The reservoir heaters may each comprise a commercially available heater bar with a thermistor for providing temperature feedback for control by, e.g., the control device 200 of the temperature of the melted ink 308 within each reservoir 320, 340. The heater bar may be inserted within a cylindrical tube formed within the aluminum material forming each reservoir 320, 340, wherein the tube may be formed the entire length or width of the corresponding reservoir 320, 340 and the corresponding heater bar placed within the tube. The melted ink 308 in the print head reservoir 340 is provided to the print head 116, which may comprise a two-dimensional array of ink jet holes (FIG. 6) delineated by a row of “top jets” and a row of “bottom jets” for discharging the melted ink 308 therethrough for printing on a container or other item. Although an embodiment of the imaging module 100 according to the present invention has been described in conjunction with two ink reservoirs 320, 340, it should be noted that only one reservoir, or more than two reservoirs may be utilized in other embodiments.

In operation, when melted ink 308 is required by the print head 116 for printing, the heater 304 is activated and as much of the ink puck(s) 140 as needed to provide the melted ink 308 for printing are melted in the ink hopper 300. The melted ink 308 travels to the buffer reservoir 320 where it fills up the reservoir to a level monitored by the float switch 332. The buffer reservoir 320 generally has enough volume to adequately buffer the flow of melted ink 308 from the hopper 300 to the print head reservoir 340. Normally, when no ink is required for printing, the buffer reservoir 320 is vented by a pipe 364, one end of which is inserted in the buffer reservoir 320, wherein the pipe 364 connects to a three-way valve 368 and to a vented opening 372. When melted ink 308 is required for printing, the buffer reservoir 320 is switched by the three-way valve 368 to a diaphragm pump 376 through a check valve 380, such that the melted ink 308 in the buffer reservoir 320 can be pressurized for “pushing” the melted ink 308 from the buffer reservoir 320 into the print head reservoir 340. Also, the check valve 316 between the hopper 300 and the buffer reservoir 320 closes when pressurization is occurring. The diaphragm pump 376, which may be connected to DC electrical power having pulse-width modulation (“PWM”) provided by, e.g., the control device 200, also includes an air inlet 384 that provides inlet air to the pump 376 through a conduit 388 having an air filter 392.

As ink 308 is consumed for printing, the float switch 356 will indicate to the control device 200 that ink is required. This initiates a fill cycle for the print head reservoir 340 to be refilled from the buffer reservoir 320 which may be performed without interrupting printing. The buffer reservoir 320 is pressurized with air from the pump 376 to push ink 308 through the filter 344 and check valve 352. When enough melted ink 308 fills the print head reservoir 340 as indicated by the float switch 356, the buffer reservoir is vented to air. When the float switch 332 indicates to the control device 200 that ink is needed in the buffer reservoir 320, the heater 304 is turned on and ink 308 is melted sufficient to refill the buffer reservoir 308. Then heater 304 is turned off. The solid ink 108 in the hopper 300 may be only melted on the bottom surface of the hopper 300 by the heater 304, and the melted ink 308 quickly congeals when the heater 304 is turned off. When the level of melted ink 308 in the print head reservoir 340 is low, more melted ink 308 is provided thereto by the buffer reservoir 320. Thus, the melted ink 308 is kept within the reservoirs 320, 340 at a controlled level and temperature for proper printing. As can be seen from the foregoing, the ink hopper 300, the buffer reservoir 320, the print head reservoir 340, and their associated components, together can be considered to comprise an ink delivery system within the imaging module 100, wherein the ink delivery system delivers hot melt wax “on demand” to the print head 116.

The print head reservoir 340 may normally be connected to a bias vacuum source 396 through a three-way valve 400 such that the array of ink jets of the print head 116 can maintain the correct meniscus. When the array needs to be purged, for example, to remove debris from the orifice plate within the print head 116 or to remove trapped air, the print head reservoir 340 is switched from the vacuum source 396 to the diaphragm pump 376 by the three-way valve 400. Once the purge is complete, the print head reservoir 340 is again switched to the vacuum source 396. The check valve 352 between the buffer reservoir 320 and the print head reservoir 340 prevents the melted ink 308 from going back into the buffer reservoir 320 during a purge. The pressure that the diaphragm pump 376 generates can be controlled by the applied PWM signal. As a result, there can be different pressures for the melted ink when the print head 116 is filled with the ink 308, is purged of the ink 308, and is also primed with the melted ink 308.

The print head 116 may be provided by PicoJet, Inc. of Hillsboro, Oreg. and may be similar to the hot melt wax ink jet printer described and illustrated in U.S. Pat. Nos. 6,464,324; 6,783,213; 6,530,653; 6,928,731, and in published U.S. pending patent application 2006/0050109—all of which are hereby incorporated by reference in their entirety. The print head 116 may substantially comprise stainless steel, resulting in a relatively low mass structure that is easily and quickly heated to the desired operating temperature. Also, by its stainless steel nature, the print head 116 is relatively inert and robust, which extends its life in operation in the typical harsh industrial environments the print head 116 is utilized in. Also, the print head 116 is not susceptible to attack from solvents or chemicals that may be present in the operating environment.

The print head 116 may operate using piezoelectric technology and may have 256 separately addressable channels (for a total of 512 jets—two jets per channel). Two orifices per channel are utilized to achieve the desired print density of 200 dots per inch along the print head and in a range of from 150 to 750 dots per inch (“dpi”) in the direction of printing, typically 450 dpi, 50-70 pl drop volume, nominally 10 kHz frequency, up to one eighth of an inch throw distance, at a print height of approximately 2.5 inches. The print head 116 may comprise an all stainless steel welded, low mass configuration, which allows the print head 116 to be easily heated to a temperature in a range of 115 to 140 degrees Centigrade typically approximately 130 degrees Centigrade. A pair of bar heaters (FIG. 9) may be provided to heat the print head 116 to the desired operating temperature. The bar heaters may be disposed vertically, one on each side the jet stack array. The print speed is dependent upon the print application, and a maximum print speed may be approximately 120 feet per minute (“fpm”). Even though a typical conveyor on a production or assembly line has a speed of 60 fpm, some relatively small boxes and parts may run faster than 60 fpm.

It should be obvious to one skilled in the art that any ink jet print head may be used that is capable of being heated to the desired operating range, is chemically compatible with the hot melt ink components, and is capable of producing the desired image. There exists in the art several ink jet print heads that are known to have been used with hot melt inks that may meet these requirements.

Referring to FIG. 4, there illustrated is a side view of an embodiment of the imaging module 100 of the invention. In this view the aforementioned optical sensor 410 is attached to one of the sides 128 of the module 100. However, if desired, the optical sensor 410 may be attached to the other side 124, or to some other location on the module 100 or even off of the module 100. The optical sensor 410 is utilized to detect when a leading edge of a container or other item to be printed by the imaging module 100 passes on a conveyor belt sufficiently close to the print head 116 to then trigger the printing of characters and/or codes on the container. As such, the optical sensor provides an output signal to the control device 200.

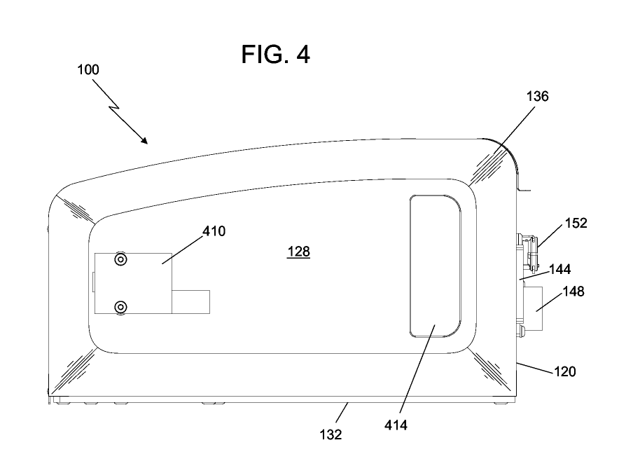

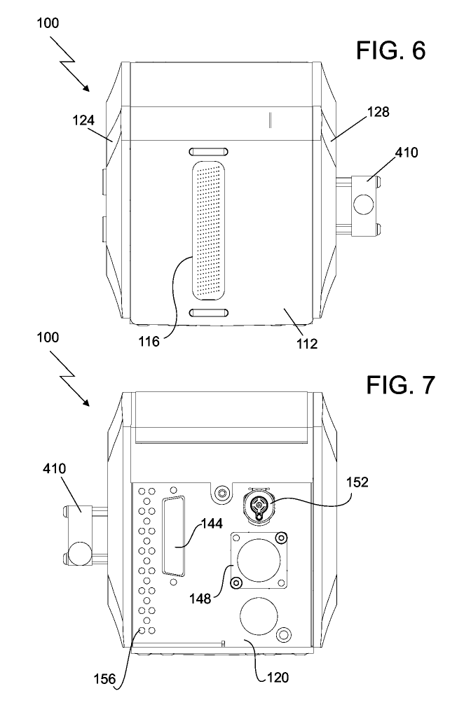

Referring also to FIGS. 5-7, there illustrated are top, front and rear views, respectively, of the embodiment of the imaging module 100 of the invention in FIG. 4. These figures also illustrate the optical sensor 410. FIG. 6 further illustrates the two-dimensional jet stack array of the print head 116 on the front 112 of the imaging module 100 in more detail. FIG. 7 further illustrates the plurality of openings 156 (e.g., round holes) that allow for the intake and exhaust of air into and out of the imaging module 100 to improve the thermal performance of the imaging module 100, as described in detail hereinafter.

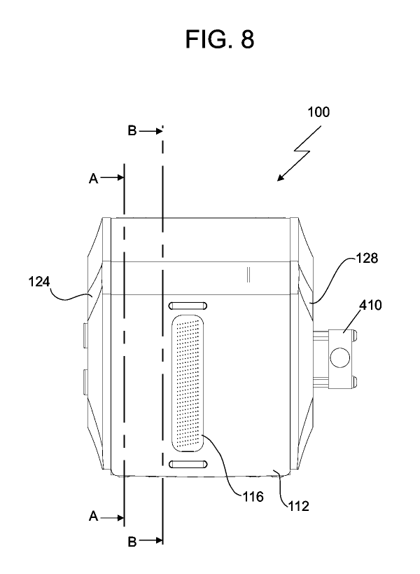

Referring to FIG. 8, there illustrated is a front view of an embodiment of the imaging module 100 of the invention, similar to the front view of FIG. 6. FIG. 9 is a cross-sectional view of the embodiment of the imaging module 100 of FIG. 8 taken along the lines A-A of FIG. 8. This figure illustrates in more detail the inclined configuration of the ink hopper 300, which facilitates the flow of the melted ink 308 in the hopper 300 towards the hopper tube 324. Also, the aforementioned heater bar and thermistor 900 is shown as being oriented perpendicular to the width dimension of the print head reservoir 340. The corresponding heater bar and thermistor 904 for the buffer reservoir 320 is shown in its approximate location. This heater bar 904 may be oriented parallel to the width dimension of the buffer reservoir 320 or in some other direction. As previously mentioned, the heater bars 900, 904 are placed in through-holes formed in the reservoir material. Also illustrated is one of the vertically oriented heater rods 908 for the print head 116. The heater rods 908 heat the print head 116 to the desired operating temperature.

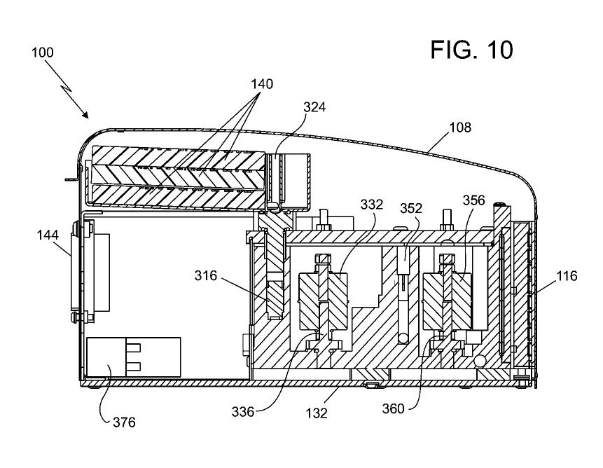

Referring to FIG. 10, there illustrated is a cross-sectional view of the embodiment of the imaging module 100 of FIG. 8 taken along the lines B-B of FIG. 8. This view shows the location of the float switches 332, 356, and associated stems 336, 360, and the check valves 316, 352.

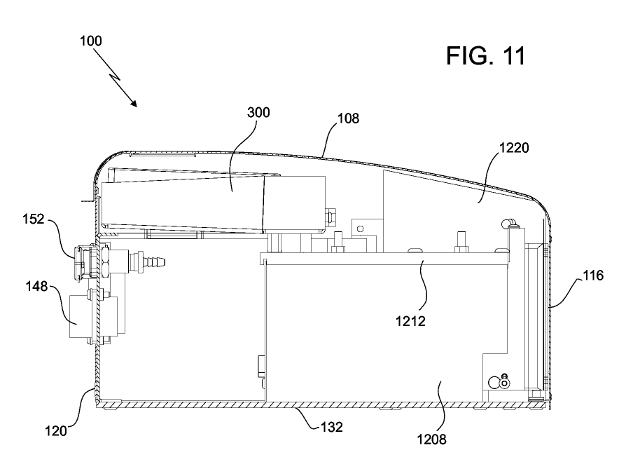

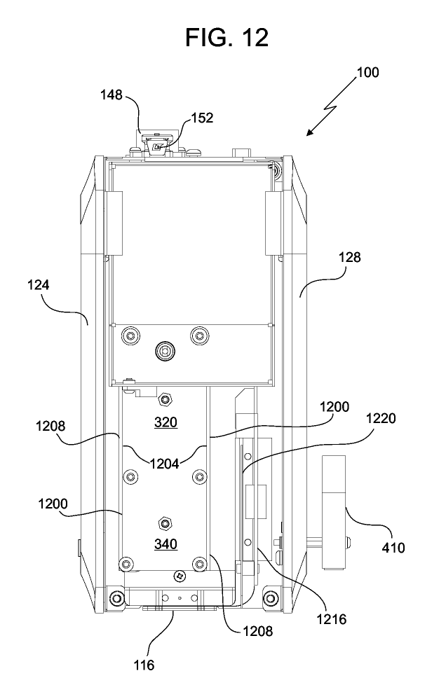

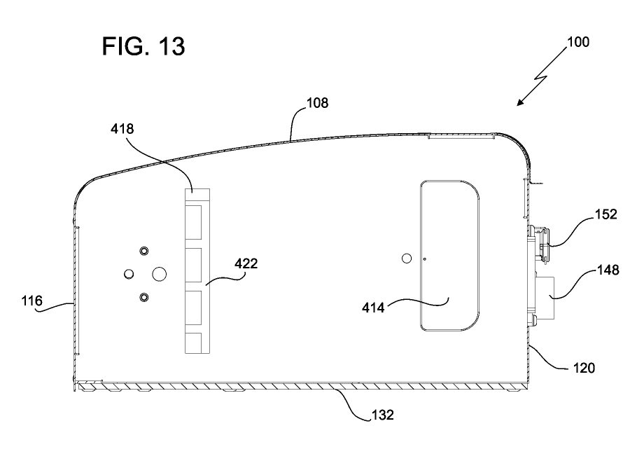

Referring to FIG. 11, there illustrated is a side view of an embodiment of the imaging module 100 of the invention with the side 124 removed. Also, referring to FIG. 12, there illustrated is a top view of an embodiment of the imaging module of the invention with the top 108 removed. Still further, referring to FIG. 13, there illustrated is another side view of an embodiment of the imaging module 100 of the invention with the opposite side 128 removed. As a result of thermal analysis performed on the imaging module 100, embodiments of the imaging module 100 include various features that increase the heat dissipation through the module 100 and reduce energy consumption by the module 100. For example, the reservoirs 320, 340 may both be insulated by creating a relatively small or thin layer of air 1200 (FIG. 12) next to the outer walls 1204 of the reservoirs 320, 340. This may be achieved by use of a heat shield or thermal barrier 1208, made from, e.g., stainless steel or similar relatively poor thermally conducting material, that surrounds the outer walls 1204, possibly including a bottom wall, of the reservoirs 320, 340 leaving the thin layer of air 1200 therebetween. This insulating heat shield has the effect of creating a stagnant, heated boundary layer around the reservoir outer walls 1204, which thermally isolates the components internal and external to the reservoirs 320, 340. The result is a reduction in the temperature at a location outside of the heat shield 1208 by as much as 35 degrees C. Also a plastic cover 1212 is utilized on top of the reservoirs 320, 340.

In addition, the float switches 332, 356 within each reservoir 320, 340 are mounted to the floor of each reservoir by the corresponding stems 336, 360, which are made from aluminum or similar material with good thermal conductivity. This has the effect of increasing the heat conduction into the melted ink 308 within the reservoirs 320, 340. The overall result is a reduction in the amount of time for the imaging module 100 to melt the ink pucks 140 (and, thus, the time for the module 100 to be ready to print the melted ink 308) to approximately ten to twenty minutes and a reduction in power to maintain the set temperature in the reservoirs.

Also, embodiments of the imaging module 100 of the invention include a printed circuit board (“PCB”) 1216 that contains the electronic components for the print head 116. The PCB 1216 may become undesirably heated by the heat from the reservoirs 320, 340. The temperature surrounding the PCB 1216 (and, thus, its mounted components) preferably should be kept as low as possible. This may be accomplished by using a board shield 1220 made from, e.g., plastic or other similar material with poor thermal conductivity, which is positioned between the reservoirs 320, 340 and the PCB 1216.

Further, to prevent the electronic components within the imaging module 100 from overheating, it is desirable to increase the flow of air through the module 100. This may be accomplished in embodiments of the invention by use of intake and exhaust holes formed in various locations within the imaging module 100. For example, the aforementioned circular holes 156 (FIGS. 2, 7) in the rear 120 of the module 100 allow for the intake and exhaust of ambient air. Also, cutouts 414 in the sides 124, 128 (FIGS. 1, 2, 4, 13) provide for ambient air intake and exhaust. Further, a cutout 418 in the casing 422 (FIG. 13) allows for airflow near the print head PCB 1216. Together, these features provide for adequate ventilation by way of ambient airflow through the imaging module 100. These features eliminate the need for a fan to keep the electronic components within the imaging module 100 from overheating. Further, they reduce power consumption by reducing heat losses and reduce the surface temperature of the casing.

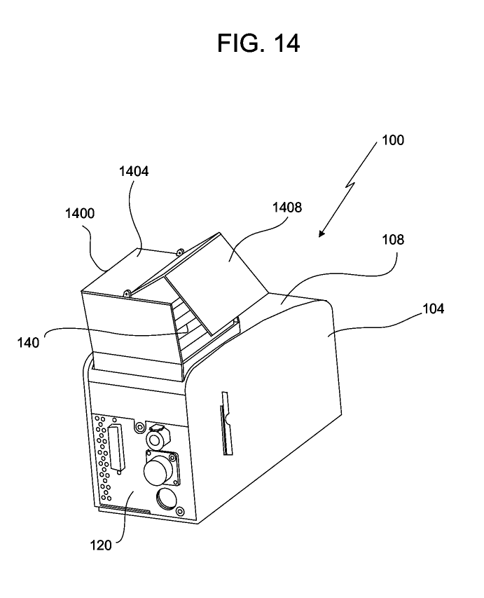

Referring to FIG. 14, there illustrated is a perspective view of an alternative embodiment of the imaging module 100 of the present invention having an external bulk ink magazine 1400. The magazine 1400 may be formed integral with a portion of the outer casing 104 of the imaging module 100, for example, at a location on the top 108. The magazine 1400 may comprise a housing 1404 made from aluminum or other suitable material. A hinged door 1408 may be provided to facilitate the loading of the ink sticks or pucks 140 inside the housing 1404. This embodiment of the imaging module 100 of the present invention allows for a larger number of ink sticks or pucks 140 to be loaded at any one time into the external bulk ink magazine 1400 of the imaging module 100 for subsequent melting and printing. The bulk ink magazine 1400 may be integral with, or may be an extension of, the integrated imaging module 100, or may be a separate container, cartridge, or magazine that may be fastened to the module 100 by a variety of methods, such as channels for sliding the container on and off, clips for securing the container, or traditional fasteners.

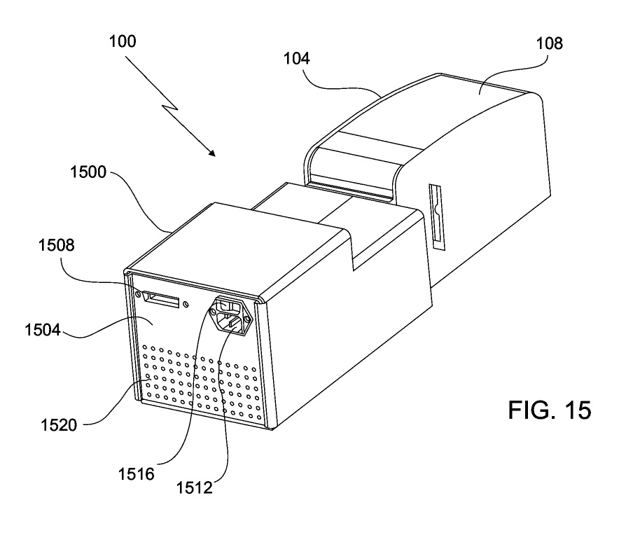

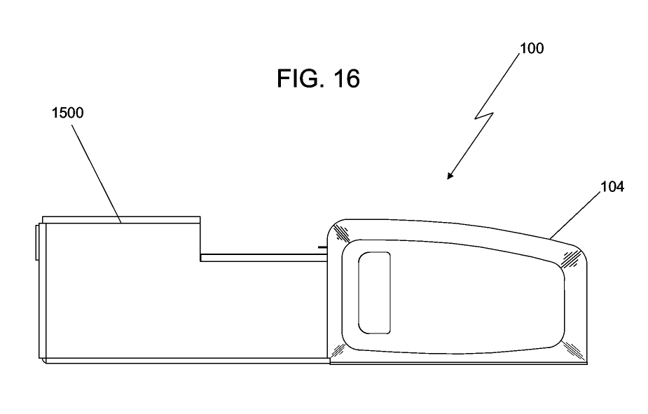

Referring to FIGS. 15 and 16, there illustrated are perspective and side views, respectively, of an alternative embodiment of the imaging module 100 of the present invention having an enlarged or extended housing 1500 that may connect with the imaging module 100 and contains various components which augment the operation of the imaging module 100. The enlarged or extended housing 1500 may comprise aluminum, steel, or other suitable material. Although not shown in FIGS. 15 and 16, the portion of the enlarged or extended housing 1500 may connect with the rear 120 (FIG. 2) of the casing 104 of the imaging module 100. That is, the enlarged or extended housing contains connectors that mate or connect with the data communication port connector 144, the power connector 148, and the vacuum port or connector 152, all on the rear 120 (FIG. 2) of the imaging module casing 104. Also, the enlarged or extended housing 1500 may contain a vacuum pump for maintaining the meniscus pressure of the liquid melted or fluid ink on the face or the print head so that it does not leak.

In this alternative embodiment, although not shown in FIGS. 15 and 16, the enlarged or extended housing 1500 may contain one or more power supplies, a vacuum pump, and an AC power and line filter. The enlarged or extended housing 1500 may also contain a print engine module “(PEM”) circuit board that contains the computer control 200 (FIG. 3), which may comprise electronic circuitry that controls the operation of the various components within the enlarged or extended housing 1500 as well as within the casing 104 of the imaging module 100. For example, the PEM may contain the electronic circuitry that controls the pneumatic system for pumping the ink, the pressure for purging the print head 116 (FIG. 3), and for switching between pressure and vacuum. The PEM may also contain the pulses or signals that drive the individual jets on the print head 116. A back 1504 may contain a data port 1508 that connects with an external source of data (e.g., an external computer), and may also include a plug 1512 for connecting a cord to a source of AC power, and an on/off switch 1516. A plurality of cooling holes 1520 may also be provided.

Although not shown in the figures, in this alternative embodiment the components within the imaging module 100 and the components within the enlarged or extended housing 1500 may be contained within a single housing, such as an enlarged or extended outer casing 104.

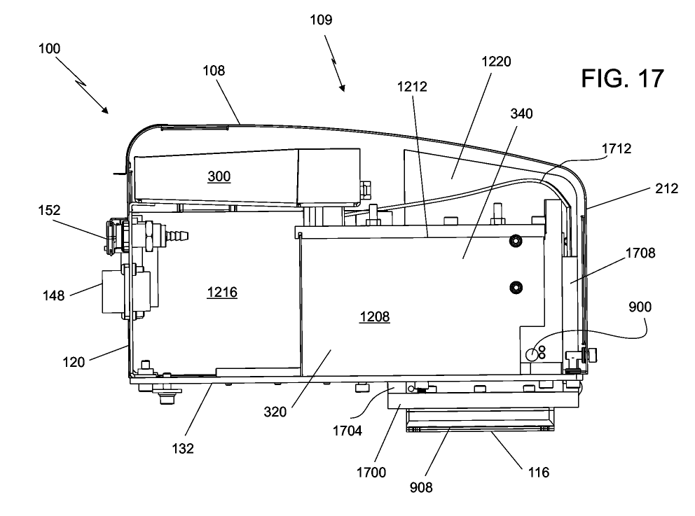

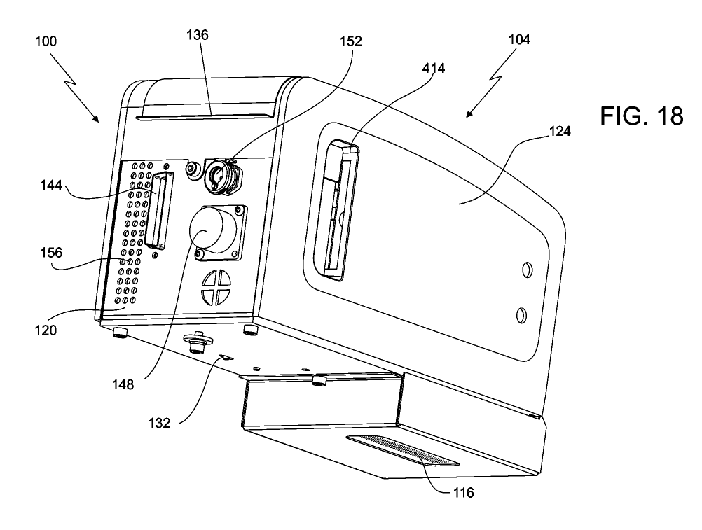

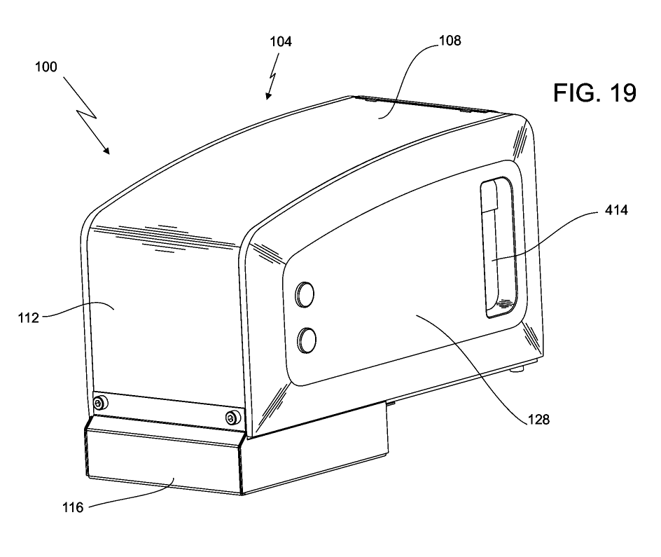

Referring to FIGS. 17-19, in an alternative embodiment of the imaging module 100 of the present invention, the module 100 includes an adaptor plate 1700, which locates the print head 116 into a position to print downwards as viewed in FIGS. 17-19. The adaptor plate 1700 may be made from preferably aluminum or similar relatively good thermal conducting material. The adaptor plate 1700 may be mounted to the bottom 132 of the casing 104 by one or more spacers 1704. The adaptor plate 1700 includes one or more heaters 908 located behind the print head 116. Also, an ink path may be located inside the adaptor plate 1700 to provide melted ink to the print head 116.

FIG. 17 also shows a second adaptor plate 1708 that is mounted vertically as shown in FIG. 17. The second adaptor plate 1708 may be used when the print head 116 is positioned vertically, as in FIGS. 1 and 2. An ink path may be located within the second adaptor plate 1708. A heater pad may be disposed on the right side of the second adaptor plate 1708. A cable 1712 may provide electrical power and/or electrical signals to the print head 116 and the heaters.

Not shown in FIGS. 17-19 is an alternative design of the adaptor plate 1700 that allows the print head 116 to print onto a surface that is moving vertically past the print head 116. It should be obvious to one of ordinary skill in the art that the adaptor plate 1700 may be configured to position the print head 116 at virtually any orientation to meet the demands of the required printing application.

Embodiments of the imaging module 100 of the present invention advance the use of clean hot melt wax ink jet printing technology as a sustainable practice for industrial packaging printing applications. The use of hot melt wax ink overcomes the aforementioned disadvantages of prior art oil-based ink printing technology and solvent ink technology. Further, in an embodiment all of the components for printing hot melt wax ink onto various materials are contained in a single module assembly having the components integrated together therein, thereby reducing the number and complexity of the components. For example, embodiments of the imaging module 100 do not utilize pipe couplings or ink filled tubes. Heating and cooling of pipe fittings cause expansion and contraction, which can loosen the fittings over time and create leaks. Also, it is known in prior art ink jet printers to use a separate ink supply, which requires the hose connecting the print head to the ink delivery system to be relatively bulky and, when cold, inflexible and therefore prone to damage. In addition, the imaging module 100 of embodiments of the invention does not utilize or require separate fluid connections to the control device 200, thereby improving the serviceability of the imaging module 100. Still further, the ink utilized by embodiments of the imaging module 100 of the invention is only melted as required, which eliminates potentially unsafe melted ink from spilling. The ink “pucks” 140 stay in solid form in the ink hopper until melted when needed for printing. Thus, increasing the capacity of the ink hopper is relatively easily achieved by stacking the ink pucks 140, for example, vertically on top of each other. Also, a user of the imaging module 100 of embodiments of the invention may use ink of different colors by having multiple imaging modules in which each module has ink of a specific color.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. An imaging module that prints ink onto a surface of an item to be printed, comprising:
a print head that prints the ink in a melted state;
an ink hopper that stores the ink in a solid state;
a first heater that heats the solid ink in the ink hopper to a melted state;
a first ink reservoir that stores the ink in the melted state and provides the ink in the melted state to the print head;
a second heater that keeps the ink in the first ink reservoir in the melted state; and
a housing that contains the print head, the ink hopper, the first and second heaters, and the first ink reservoir.

2. The imaging module of claim 1, further comprising a second ink reservoir that receives the melted ink from the ink hopper and provides the melted ink to the first ink reservoir in response to a demand indication that the second ink reservoir needs additional melted ink, and further comprising a third heater that keeps the ink in the second ink reservoir in the melted state, wherein the second ink reservoir and the third heater are contained within the housing.

3. The imaging module of claim 1, wherein the ink hopper includes an inclined bottom surface and a vent tube that protrudes above the ink in the ink hopper to allow air to escape while the ink is melting and to prevent a dam of the ink from forming at a front of the ink hopper, wherein the vent tube includes an opening through which the melted ink flows into the first ink reservoir.

4. The imaging module of claim 2, further comprising a pump that selectively pumps the melted ink from the second ink reservoir to the first ink reservoir.

5. The imaging module of claim 4, further comprising a control device that controls operation of the first, second and third heaters to melt the ink and controls operation of the pump to provide the melted ink to the print head.

6. The imaging module of claim 5, wherein the housing further contains the control device, a source of electrical power, and a vacuum source.

7. The imaging module of claim 1, further comprising a container that stores a portion of the solid ink beyond an amount of the solid ink stored in the ink hopper, wherein the container is located integral with the housing or external to the housing.

8. An imaging module that prints hot melt wax ink in a certain configuration onto a surface of an item to be printed, comprising:
a print head that prints the hot melt wax ink in the certain configuration in a melted state onto the surface of the item to be printed;
an ink hopper that stores the hot melt wax ink in a solid state;
a first heater that heats the solid hot melt wax ink in the ink hopper to a melted state;
a first ink reservoir that stores the melted ink state and provides the melted ink to the print head;
a second heater that keeps the melted ink in the first ink reservoir; and
a housing that contains the print head, the ink hopper, the first and second heaters, and the first ink reservoir.

9. The imaging module of claim 8, further comprising a second ink reservoir that receives the melted ink from the ink hopper and provides the melted ink to the first ink reservoir in response to a demand indication that the second ink reservoir needs additional melted ink, and further comprising a third heater that keeps the ink in the second ink reservoir in the melted state, wherein the second ink reservoir and the third heater are contained within the housing.

10. The imaging module of claim 8, wherein the ink hopper includes an inclined bottom surface and a vent tube that protrudes above the ink in the ink hopper to allow air to escape while the ink is melting and to prevent a dam of the ink from forming at a front of the ink hopper, wherein the vent tube includes an opening through which the melted ink flows into the first ink reservoir.

11. The imaging module of claim 9, further comprising a pump that selectively pumps the melted ink from the second ink reservoir to the first ink reservoir.

12. The imaging module of claim 11, further comprising a computer control device that controls operation of the first, second and third heaters to melt the hot melt wax ink and controls operation of the pump to provide the melted ink to the print head.

13. The imaging module of claim 12, wherein the housing further contains the control device, a source of electrical power, and a vacuum source.

14. The imaging module of claim 8, further comprising a container that stores a portion of the solid ink beyond an amount of the solid ink stored in the ink hopper, wherein the container is located integral with the housing or external to the housing.

15. An imaging module that prints ink onto a surface of an item to be printed, comprising:
an ink hopper that stores the ink in a solid state;
a first heater that heats the solid ink in the ink hopper to a melted state;
a first ink reservoir that receives the melted ink from the ink hopper and stores the melted ink;
a second heater that keeps the ink in the first ink reservoir in the melted state;
a second ink reservoir that receives the melted ink from the first ink reservoir in response to a demand indication that the second ink reservoir needs additional melted ink;
a third heater that keeps the ink in the second ink reservoir in the melted state;
a print head that receives the melted ink from the second ink reservoir; and
a housing that contains the ink hopper, the first, second and third heaters, the first and second ink reservoirs, and the print head.

16. The imaging module of claim 15, wherein the ink hopper includes an inclined bottom surface and a vent tube that protrudes above the ink in the ink hopper to allow air to escape while the ink is melting and to prevent a dam of the ink from forming at a front of the ink hopper, wherein the vent tube includes an opening through which the melted ink flows into the first ink reservoir.

17. The imaging module of claim 15, further comprising a pump that selectively pumps the melted ink from the first ink reservoir to the second ink reservoir, and from the second ink reservoir to the print head.

18. The imaging module of claim 17, further comprising a control device that controls operation of the first, second and third heaters to melt the ink and control the operation of the pump to provide the melted ink to the print head.

19. The imaging module of claim 18, wherein the housing further contains the control device, a source of electrical power, and a vacuum source.

20. The imaging module of claim 15, further comprising a container that stores a portion of the solid ink beyond an amount of the solid ink stored in the ink hopper, wherein the container is located integral with the housing or external to the housing.
